(19) United States
(12) Patent Application Publication
(10) Pub. No.: US 2011/0263371 A1
(43) Pub. Date: Oct. 27, 2011

(54) DRIVE ASSEMBLY AND STARTING PROCESS OF A VEHICLE

(75) Inventors: Bernd Vahlensieck, Markdorf (DE); Johannes Kaltenbach, Friedrichshafen (DE)

(73) Assignee: ZF Friedrichshafen AG, Friedrichshafen (DE)

(21) Appl. No.: 13/084,677

(22) Filed: Apr. 12, 2011

(30) Foreign Application Priority Data
Apr. 21, 2010 (DE) 10 2010 028 030.5

(51) Int. Cl. B60K 6/365

(52) U.S. Cl. 475/5; 180/65.22; 903/902

(57) ABSTRACT

A drive assembly for a commercial vehicle, in particular a mobile working machine. The drive assembly comprises an internal combustion engine (1) and a gear system transmission (2) and a starting element for starting and maneuvering. The starting element is a planetary gear system (7) coupled to both the internal combustion engine (1) and to the transmission (2), and also coupled to at least one electric drive (9) for torque support. The starting element is additionally coupled to at least one hydraulic drive (11) for torque support during starting and maneuvering. Furthermore a method for carrying out a starting process with such a drive assembly is proposed, in which, during starting or maneuvering, the supporting torque is applied electrically to a planetary gear system (7) and the electrically produced torque is also assisted by a hydraulically produced torque.

This application claims priority from German patent application serial no. 10 2010 028 030.5 filed Apr. 21, 2010.

### FIELD OF THE INVENTION

The present invention concerns a drive assembly for a commercial vehicle, in particularfor a mobile working machine having an internal combustion engine and a gearshift transmission and with a starting element for starting and maneuvering. Furthermore, the invention concerns a method for carrying out a starting process.

### BACKGROUND OF THE INVENTION

From the document DE 199 34 696 A1, for example, an electrodynamic drive system is known for a vehicle with a drive machine and a gearshift transmission, and with a planetary gear system as the starting element. A ring gear of the planetary gear system is connected to the drive machine and the planetary carrier is connected to the gearshift transmission. Moreover, a sun gear of the planetary gear system is coupled to an electric motor so that, overall, a wear-free starting element for the vehicle is produced. The known electrodynamic drive system has the disadvantage that the electric motor must be designed to supply high power so as to be able to provide, during the starting process, the necessary supporting torque at the planetary gear system.

### SUMMARY OF THE INVENTION

The purpose of the present invention is to propose a drive assembly and a method for carrying out a starting process with the drive assembly of the type described at the beginning, with which wear-free and also energetically favorable starting and maneuvering can be carried out.

The objective addressed by the invention is achieved by a drive assembly for a commercial vehicle, for example a mobile working machine or the like, having an internal combustion engine and a transmission and with a wear-free starting element for starting and maneuvering, which is in the form of a planetary gear system coupled to the internal combustion engine and the gearshift transmission, which is coupled to at least one electric drive for torque support during the starting process such that, for torque support, the starting element is additionally coupled to at least one hydraulic drive.

In this way, the supporting torque required during starting is applied to an element of the planetary gear system not solely by the electric drive, but also by the hydraulic drive, so that the electric motor used, for example, to apply the electric torque is correspondingly assisted, whereby at least the disadvantages known from the prior art are avoided. Consequently, a drive assembly with an electro-hydraulic starting element is produced.

In a first possible embodiment variant of the invention, it can be provided that the hydraulic drive and the electric drive, for applying the necessary supporting torque, are preferably arranged parallel to one another and connected to an element of the planetary gear system. Thus, the supporting torque necessary, in accordance with the desired drive torque, can be applied to a common element of the planetary gear system both by the hydraulic drive and also by the electric drive together.

Preferably, the internal combustion engine can be coupled to the ring gear, the transmission to the web or planetary carrier, and the electric and hydraulic drives conjointly to the sun gear of the planetary gear system. Other designs of the individual connections to the elements of the planetary gear system are also possible.

To allow for a rotation speed reversal in the speed variation during a typical starting operation with the hydraulic drive as well, according to a further development of the invention, it can be provided that on the hydraulic drive, for example a pump drive or the like, at least a freewheel or similar is formed, so that when the rotation direction reversal has been reached the pump is no longer driven.

Another possibility for taking appropriate account of the rotation speed reversal, during the starting process, can provide that the hydraulic drive, or the hydraulic system supplying the hydraulic drive, comprises at least one control valve or the like. This makes it possible, for example by appropriate control, to achieve a neutral position or a direction reversal of the delivery of the hydraulic drive. Preferably, a 4-3-way valve can be used as the said valve.

In a related feature of the invention, in the proposed drive assembly it can be provided that as the hydraulic drive a displacement pump or a pump with variable displacement volume, or even a hydraulic pump that can be operated either in pumping or in motor operation is used. Other machine elements too can be used as the hydraulic drive, in order to produce overall an electro-hydraulic starting element in the drive assembly, according to the invention, and to be able to apply the supporting torque to a common element of the planetary gear system by means of the said machine element and the electric machine.

The objective addressed by the invention is also achieved by a method for carrying out a starting process, preferably with the drive assembly described above or one similar to it, such that according to the method, during starting or maneuvering, a supporting torque is applied by electric motor means to an element of the planetary gear system, which is assisted by a hydraulically produced torque.

In the context of the method according to the invention it is also possible, at least for a time, to produce only a hydraulic torque or an electric torque for applying the overall supporting torque.

In the proposed method it can also be provided, for example, that the torque produced electro-mechanically or by the electric motor is set such that with a specified, hydraulically produced torque the required supporting torque corresponding to the desired drive torque is obtained. This means that the electric motor torque is obtained from the difference between the necessary supporting torque and the specified hydraulic torque. When there is no desire to drive, i.e., no supporting torque is needed, the electric machine can work as a motor for electric pump operation.

It is also possible for a pump pressure, in the hydraulic supply system, to be set such that a hydraulic torque is obtained from the difference between the required supporting torque and a specified, electrically produced torque. For example, the torque produced by the electric motor can be the maximum possible generator torque of the electric machine.

According to a related feature of the invention, it can be provided that when a valve is used to control a pump drive for producing the hydraulic torque, the valve is brought to a neutral position if no supporting torque, or if only a very small one is needed and if too little electrical energy is available for driving the pump electrically. Furthermore, by appropriate adjustment of the pump drive, a desired pump torque can be applied as the hydraulic torque. Thanks to the possibility of adjusting the hydraulic drive, a rotation speed reversal can be produced in the speed variation during a starting process with no difficulty.

Another possible way to produce a speed reversal with the hydraulic drive can provide that a hydraulic pump, used for example to apply the hydraulic torque in the speed variation, is operated as a pump before the speed reversal and as a motor after the speed reversal.

The proposed method can be used both with the drive assembly, according to the invention, and with other drive systems to carry out a wear-free and electro- hydraulic starting process.

### BRIEF DESCRIPTION OF THE DRAWINGS

Below, the invention is explained further with reference to the drawings which show:

FIG. 1: A schematic view of a possible embodiment variant of a drive assembly, according to the invention, with an electro-hydraulic starting element

FIG. 2: A diagram showing rotation speed variations of the elements of a planetary gear system during a start up to the synchronous point

FIG. 3: A schematic view of a hydraulic drive with a freewheel

FIG. 4: A schematic view of an alternative design of a hydraulic drive, with a valve

FIG. 5: A schematic view of a related design of the hydraulic drive, with a displacement pump, and

FIG. 6: A schematic view of another design of the hydraulic drive, as a hydraulic pump

### DETAILED DESCRIPTION OF THE PREFERRED EMBODIMENTS

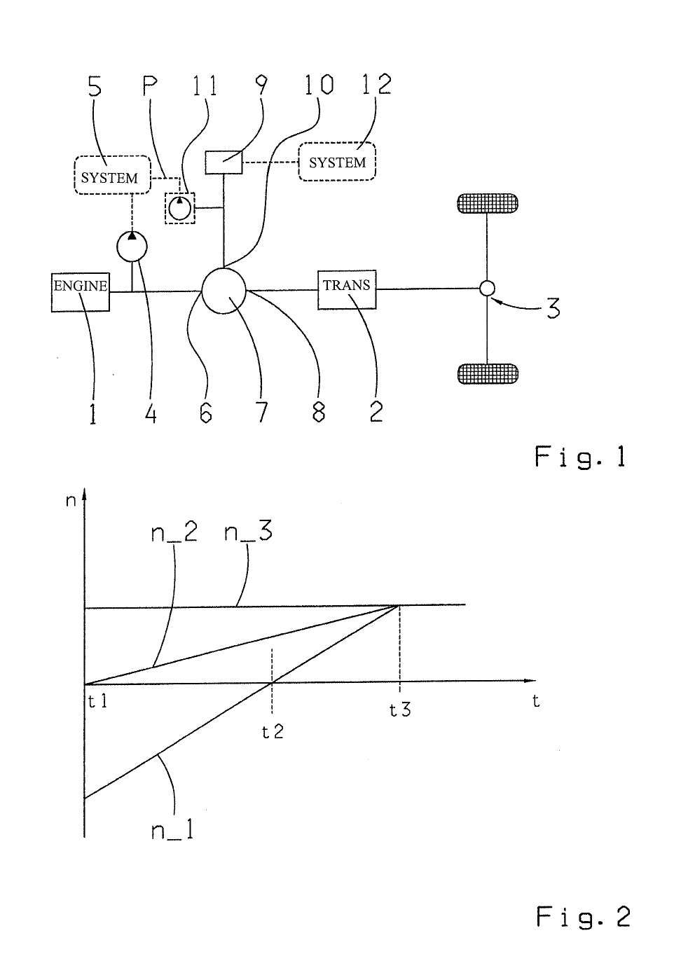

FIG. 1 shows a possible example embodiment of a drive assembly, according to the invention, for a vehicle, in particular for a mobile working machine. The drive assembly comprises an internal combustion engine 1 as the driving machine and a transmission 2, which is connected to the drive output 3 of the vehicle or working machine. The internal combustion engine 1 drives a supply pump 4, which supplies pressure medium to a hydraulic system 5. The transmission 2 can be in the form of a gearshift transmission or a continuously variable transmission, in particular a hydraulic power-branched continuously variable transmission.

The internal combustion engine 1 is coupled, via a ring gear 6 of a planetary gear system 7, and the transmission 2, via a web 8 or planetary carrier, to the planetary gear system 7. The planetary gear system 7 is coupled with an electric drive 9, via a sun gear 10 of the planetary gear system 7, and serves as a wear-free starting element since, in the case of a mobile working machine for example with low driving speed and high driving resistance, starting can take a long time, for example when a wheel loader is moving a pile of rubble with its scoop. As the electric drive 9 for example an electric machine can be used, which is connected to an electrical system 12.

According to the invention, it is provided that the planetary gear system 7 is additionally coupled to a hydraulic drive 11 parallel to the electric drive 9. In this way, an electro-hydraulic drive starting element is created with which the necessary torque support, during the starting process, can be provided at the sun gear 10 of the planetary gear system, both by the hydraulic drive 11 and by the electric drive.

FIG. 2 illustrates a normal starting process in the form of a diagram showing the speed variations of the elements of the planetary gear system over time, starting from a time t1, that is the beginning of starting, up to a time t3 which corresponds to the synchronous point. With the drive assembly described earlier as an example, the speed variation n_1 corresponds to the rotation speed of the sun gear, which is coupled to the hydraulic drive 11 and the electric drive 9. The speed variation n_2 corresponds to the speed of the web 8 of the planetary gear system 7, which is connected to the transmission input shaft of the transmission 2. Finally, the speed variation n_3 corresponds to the speed of the ring gear 6 of the planetary gear system 7, which is coupled to the internal combustion engine 1.

The speed n_3 of the ring gear 6 or the internal combustion engine 1, during the starting process, is constant from time t1 to t3 and corresponds, for example, to the idling speed. The speed n_2 of the web 8 or transmission input shaft begins at zero and increases continuously until the value of the speed n_3 is reached at the synchronous point. The speed n_1 begins at a negative value and, as far as time t2 which corresponds to a speed reversal, decreases to the zero value and thereafter increasing continuously to the idling speed and to the value n_3 at time t3, at the synchronous point.

Form the speed variation of the speed n_1 it is evident, that between times t1 and t2, the supporting torque has to be applied as a braking torque and from the speed reversal, i.e., after time t2, as a positive supporting torque by the hydraulic drive 11 and the electric drive 9, until time t3 is reached.

The supporting torque required, for example at the sun gear 10 of the planetary gear system 7, is thus obtained as the sum of the electric torque applied by the electric drive 9 and the hydraulic torque applied by the hydraulic drive 11. The said hydraulic torque is obtained as a function of the hydraulic pressure provided by the hydraulic system 5, or pump pressure P, which can be measured in the vehicle.

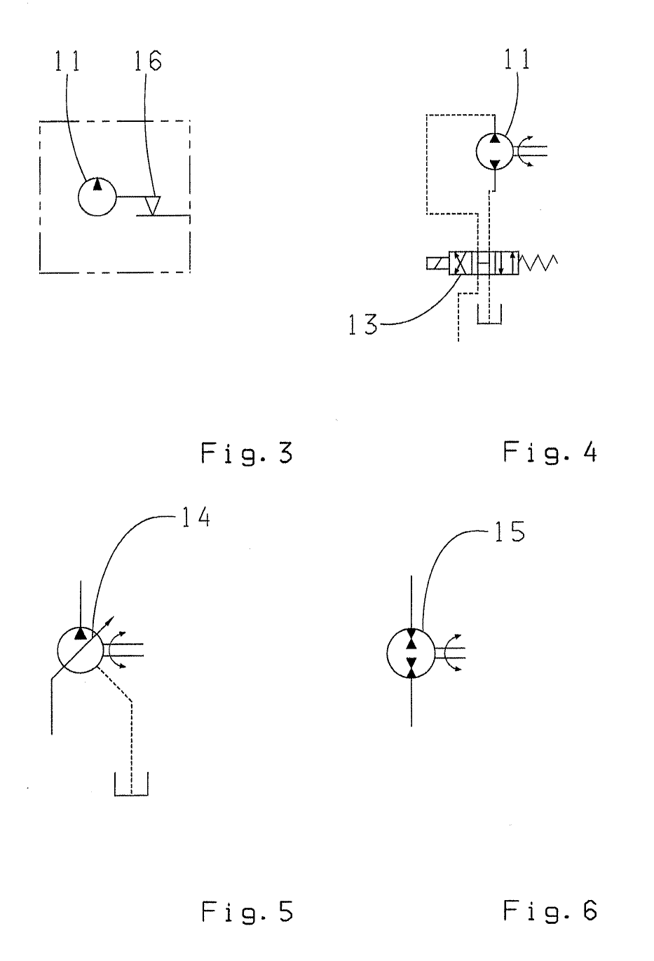

In FIG. 3, the hydraulic drive 11 is in the form of a pump with a freewheel 16 so that, after the speed reversal at time t2, the pump drive is no longer driven.

According to FIG. 4, the hydraulic drive 11 is again shown as a pump and a 4-3-way valve is used, in particular, to control the pump a valve 13. With the valve 13, a neutral pump position and a direction reversal of the pump's delivery can be produced. Thus, the valve can adopt its neutral position, a central position in FIG. 4, when no supporting torque or only a very small one is needed. At the time t2 of the speed reversal, the valve 13 can be switched to the other flow direction so that after the speed reversal the hydraulic delivery direction is nevertheless maintained.

In FIG. 5, a displacement pump 14 with variable displacement is provided as the hydraulic drive 11, the adjustment of the displacement pump 14 being designed such that a desired hydraulic torque is obtained, and the electric torque is predetermined and is, as a rule, the maximum possible generator torque of the electric machine. After the speed reversal, the displacement pump 14 can be adjusted so that the hydraulic delivery direction is nevertheless maintained.

Finally, in FIG. 6 the hydraulic drive 11 is in the form of a hydraulic pump 15 that can be operated either as a pump or as a motor. It is operated as a pump, from time t1 to time t2, and as a motor, from time t2 to time t3. When it is operating as a motor, the supply pump 4 delivers the pressure required.

The pump pressure P is set by the hydraulic system 5 in such manner that a desired hydraulic torque is obtained, the electric torque being regarded as a given and being, as a rule, the maximum possible motor torque of the electric machine.

### INDEXES

1 Internal combustion engine

2 Transmission

3 Drive output

4 Supply pump

5 Hydraulic system

6 Ring gear

7 Planetary gear system

8 Web

9 Electrically produced torque

10 Sun gear

11 Hydraulically produced torque

12 Electric system

13 Valve

14 Displacement pump

15 Hydraulic pump

16 Freewheel

1-15. (canceled)

16. A drive assembly for a commercial vehicle, the drive assembly comprising:
an internal combustion engine (1);
a transmission (2);
a starting element for starting and maneuvering the vehicle, the starting element being a planetary gear system (7) coupled to both the internal combustion engine (1) and the transmission (2); and
at least one electric drive (9) also being coupled to the starting element for providing torque support thereto;
wherein at least one hydraulic drive (11) is additionally coupled to the starting element for providing torque support thereto.

17. The drive assembly according to claim 16, wherein the hydraulic drive (11) and the electric drive (9) are both connected to the planetary gear system (7) in parallel to one another.

18. The drive assembly according to claim 16, wherein the internal combustion engine (1) is coupled to the ring gear (6) of the planetary gear system (7), the transmission (2) is coupled to the web (8) of the planetary gear system (7), and the electric drive (9) and the hydraulic drive (11) are both together coupled to the sun gear (10) of the planetary gear system (7).

19. The drive assembly according to claim 16, wherein at least one freewheel (16) is provided on the hydraulic drive (11).

20. The drive assembly according to claim 16, wherein the hydraulic drive (11) is controlled by at least one valve (13).

21. The drive assembly according to claim 20, wherein the at least one valve (13) is a 4-3-way valve.

22. The drive assembly according to claim 16, wherein the hydraulic drive (11) is a displacement pump (14) with a variable displacement volume.

23. The drive assembly according to claim 16, wherein the hydraulic drive is a hydraulic pump (15) that is operatable as either a pump or a motor.

24. The drive assembly according to claim 16, wherein the electric drive (9) is an electric machine that is operatable as either a generator or a motor.

25. The drive assembly according to claim 16, wherein the commercial vehicle is a mobile working machine.

26. A method of carrying out a starting process is a drive assembly of a commercial vehicle comprising an internal combustion engine (1), a transmission (2), a starting element for starting and maneuvering the vehicle with the starting element being a planetary gear system (7) coupled to both the internal combustion engine (1) and the transmission (2), at least one electric drive (9) coupled to the starting element for providing torque support thereto, and at least one hydraulic drive (11) is additionally coupled to the starting element for providing torque support thereto, the method comprising the step of, during starting or maneuvering:
electrically applying a supporting torque to the planetary gear system (7) and assisting the electrically produced torque with a hydraulically produced torque.

27. The method according to claim 26, further comprising the step of, with a predetermined hydraulically produced torque, setting the electrically produced torque such that a necessary supporting torque is applied as a function of a desire to start.

28. The method according to claim 26, further comprising the step of, with a predetermined electrically produced torque, setting the hydraulically produced torque such that a necessary supporting torque is applied as a function of a desire to start.

29. The method according to claim 26, further comprising the step of, if only a small supporting torque is required, reducing one of the hydraulically produced torque and the electrically produced torque to zero.

30. The method according to claim 26, further comprising the step of causing a speed reversal, during a starting process, when the supporting torque is applied by reversing a flow direction in the hydraulic drive (11).

31. The method according to claim 26, further comprising the step of using a hydraulic pump (15) that can be operated either as a motor or as a pump, operating the hydraulic pump (15), as a pump, to apply the hydraulically produced torque before a speed reversal, at time (t2), and then operating the hydraulic pump as a motor after the speed reversal, at time (t2).

32. The method according to claim 26, further comprising the step of using a mobile working machine as the commercial vehicle.
